(19) United States
(12) Patent Application Publication
(10) Pub. No.: US 2016/0223577 A1
(43) Pub. Date: Aug. 4, 2016

(54) SYSTEMS AND METHODS FOR TRACKING MOTION OF A BICYCLE OR OTHER VEHICLES

(71) Applicant: Vision Service Plan, Rancho Cordova, CA (US)

(72) Inventors: Richard Chester Klosinski, JR., Sacramento, CA (US); Meghan Kathleen Murphy, Davis, CA (US); Matthew Allen Workman, Sacramento, CA (US); Jay William Sales, Citrus Heights, CA (US)

(21) Appl. No.: 14/610,501

(22) Filed: Jan. 30, 2015

(51) Int. Cl. G01P 3/50; G01P 3/44; G01C 22/00; G01B 7/30

(52) U.S. Cl. CPC G01P 3/50; G01B 7/30; G01P 3/44; G01C 22/002

(57) ABSTRACT

A vehicle tracking system, in various embodiments, is configured to measure vehicle speed, heading, distance travelled, acceleration, and other motion related measurements based at least in part on magnetic field measurements taken by one or more magnetometers. In a particular embodiment, the system comprises one or more magnetometers (e.g., that may be embedded in one or more wearable devices, such as eyewear) and at least one magnet disposed on a portion of the vehicle such as the vehicle's wheel. The system is configured to receive magnetic field information associated with the at least one magnet using the one or more magnetometers and determine the speed and other data based at least in part on the magnetic field information. In various embodiments, the system is configured to track movement and speed of a bicycle.

### BACKGROUND

A driver or rider of a bicycle or other vehicle may desire to measure and track various performance metrics related to the movement of the vehicle such as speed, distance travelled, etc. Current systems for tracking such metrics are limited in terms of the information that they provide and often include complex and expensive assemblies of parts. Accordingly, there is a need for improved systems and methods for tracking vehicles.

### SUMMARY

A computer-implemented method of determining vehicle motion, in various embodiments, comprises: (1) determining, by a processor, using one or more magnetometers, magnetic field information for a first magnet mounted on a wheel of a vehicle at a particular time; (2) determining, by a processor, based at least in part on the magnetic field information, an angular velocity of the vehicle wheel at the particular time; (3) determining, by a processor, based at least in part on the angular velocity, a speed of the vehicle at the particular time; and (4) displaying the speed of the vehicle to a user of the vehicle. In particular embodiments, the system is further configured to determine a heading of the vehicle and an instantaneous speed of the vehicle over a particular period of time. In still further embodiments, the system is configured to generate a visual representation of a path taken by the vehicle over the particular period of time and display the visual representation to the user.

A computer system for determining and tracking bicycle movement data, in various embodiments, comprises at least one processor and at least one magnetometer. In particular embodiments, the computer system is configured for receiving, from the at least one magnetometer at a first time, a first magnetic field measurement for a first magnet disposed on a portion of a bicycle selected from the group consisting of: (i) a wheel of the bicycle; and (ii) a portion of a pedal of the bicycle. In particular embodiments, the system is further configured for: (1) receiving, from the at least one magnetometer at a second time, a second magnetic field measurement for the first magnet; (2) determining, based at least in part on the first magnetic field measurement and the second magnetic field measurement, a velocity of the bicycle; and (3) storing the velocity of the bicycle in at least one data store.

A computer-implemented method of determining instantaneous angular velocity of a wheel of a vehicle, according to some embodiments, comprises: (1) receiving, by a processor, from one or more magnetometers, a plurality of magnetic field measurements for a first magnet mounted on the wheel over a particular period of time; and (2) determining, by a processor, based at least in part on the plurality of magnetic field measurements, an instantaneous angular velocity of the wheel at a particular time during the particular period of time. In other embodiments, determining the instantaneous angular velocity of the wheel at the particular time comprises determining, by a processor, based at least in part on the plurality of magnetic field measurements, an angle of revolution of the wheel associated with each particular one of the plurality of magnetic field measurements. In still other embodiments, the method further comprises: (1) determining, based at least in part on the instantaneous angular velocity of the wheel, an instantaneous velocity of the vehicle; (2) determining, by a processor, based at least in part on the plurality of magnetic field measurements, a plurality of instantaneous angular velocities of the wheel over the particular period of time; (3) determining, by a processor, based at least in part on the plurality of instantaneous angular velocities of the wheel, a distance travelled by the vehicle during the particular period of time; and (4) displaying, by a processor, the instantaneous velocity and the distance travelled to a rider of the vehicle, or other individual. In particular embodiments, the method may also include storing the data determined above in computer memory for later reference.

### BRIEF DESCRIPTION OF THE DRAWINGS

Various embodiments of a system and method for determining, tracking, and storing performance and movement information for one or more vehicles are described below. In the course of this description, reference will be made to the accompanying drawings, which are not necessarily drawn to scale, and wherein:

FIG. 1 is a block diagram of a vehicle tracking system in accordance with an embodiment of the present system;

FIG. 2 is a schematic diagram of a computer, such as the vehicle tracking server of FIG. 1, that is suitable for use in various embodiments;

FIG. 3 is an exemplary wearable computing device as shown in FIG. 1; and

FIG. 4 depicts a flow chart that generally illustrates various steps executed by a Vehicle Tracking Module that, for example, may be executed by the vehicle tracking server of FIG. 1.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, a system for tracking bicycle (or other vehicle) movement, speed, and other performance metrics comprises one or more magnetometers, and one or more magnets disposed on a particular portion of the bicycle. In particular embodiments, the one or more magnetometers may be embedded in any suitable computing device such as, for example, a suitable mobile computing device (e.g., a smartphone, tablet, or stand-alone vehicle tracking device), a suitable wearable computing device (e.g., wristband, wristwatch, pair of eyewear, etc.), or any other suitable device.

In various embodiments, the system is configured to determine and track movement data for the bicycle based at least in part on magnetic field information associated with the one or more magnets determined by the one or more magnetometers. In a particular embodiment, the vehicle tracking system is configured to determine and track movement data for the bicycle such as, for example, linear speed and/or acceleration of the bicycle (e.g., relative to a support surface such as the Earth), angular speed and/or acceleration of one or more wheels of the bicycle, altitude or change in altitude of the bicycle, angle of incline and/or decline of the bicycle, direction of travel of the bicycle, distance travelled by the bicycle, or any other suitable metric related to movement of the bicycle.

In various embodiments, the system is configured to use magnetic field information determined by the one or more magnetometers in combination with information determined by one or more other sensors, such as one or more rider health sensors. In various embodiments, the one or more other sense may include, for example, one or more accelerometers, one or more gyroscopes, one or more digital compasses, one or more heart rate monitors, one or more pressure sensors, etc. to determine information such as, for example: (1) a start or a stop time for a particular activity performed on the bicycle (e.g., such as a race); (2) an energy expenditure of a rider of the bicycle; (3) a total saddle time for the rider of the bicycle; and/or (4) any other suitable information or feedback associated with the rider or the bicycle.

In various embodiments, the system is particularly useful for tracking distance travelled, speed, direction, etc. for a bicycle that is not travelling on a fixed path (e.g., such as in the case of a mountain bike or other off-trail bicycle). In various embodiments, the system may offer a method for tracking bicycle distance travelled and other measures without having to rely on a distance of a particular road or path on which the bicycle is or was travelling.

In various embodiments, the system is configured to display bicycle movement data and other information to a user (e.g., such as the rider of the bicycle), for example, on a display associated with a computing device in which the one or more magnetometers are embedded or on any other suitable display. Although the vehicle tracking system is generally described herein in the context of a bicycle, it should be understood that the vehicle tracking system may be used to determine movement, speed, and other data for any other suitable vehicle.

### Exemplary Technical Platforms

As will be appreciated by one skilled in the relevant field, the present invention may be, for example, embodied as a computer system, a computer-implemented method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

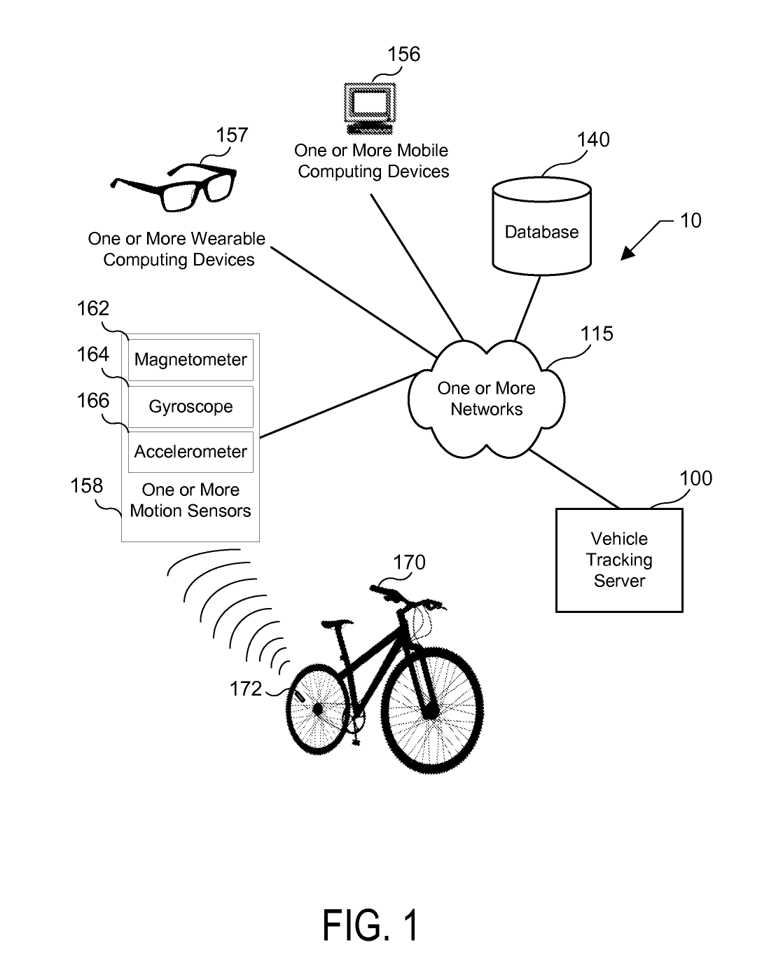

FIG. 1 is a block diagram of a Vehicle Tracking System 10 according to a particular embodiment. As may be understood from this figure, the Vehicle Tracking System 10 includes One or More Computer Networks 115, a Vehicle Tracking Server 100, a Database 140, and One or More Mobile Computing Devices 156 (e.g., such as a smart phone, a tablet computer, a laptop computer, etc.), One or More Wearable Computing Devices 157 (e.g., such as a pair of eyewear, a wristwatch, etc.), and/or One or More Motion Sensors 158, which may, in various embodiments, be integrated with the One or More Mobile Computing Devices 156 or the One or More Wearable Computing Devices 157. In particular embodiments, the One or More Computer Networks 115 facilitate communication between the Vehicle Tracking Server 100, Database 140, One or More Mobile Computing Devices 156, One or More Wearable Computing Device 157, and One or More Motion Sensors 158. In various embodiments, the Vehicle Tracking System 10 further comprises One or More Magnets 172 disposed (e.g., mounted on) a Vehicle 170 (e.g., such as a bicycle). In various embodiments, the One or More Magnets 172 may include any suitably shaped magnet, such as, for example, one or more suitable bar magnets, one or more suitable disk magnets, or one or more magnets having any other suitable shape. In various embodiments, the One or More Magnets 172 may comprise, for example, one or more rare-earth magnets (e.g., one or more Neodymium Iron Boron magnets, one or more Samarium Cobalt magnets, etc.), one or more Alnico magnets, one or more ceramic magnets, one or more ferrite magnets, or any other magnet comprising any other suitable material. In other embodiments, the One or More Magnets 172 may comprise any suitable component capable of generating a magnetic field that is sufficiently strong such that the Magnetometer 162 is capable of detecting the magnetic field.

The one or more computer networks 115 may include any of a variety of types of wired or wireless computer networks such as the Internet, a private intranet, a mesh network, a public switch telephone network (PSTN), or any other type of network (e.g., a network that uses Bluetooth, Low Energy Bluetooth, or near field communications to facilitate communication between computers). The communication link between the Vehicle Tracking Server 100 and the Database 140 may be, for example, implemented via a Local Area Network (LAN) or via the Internet. The communication link between the One or More Mobile Computing Devices 156 and the One or More Motion Sensors 158 may be, for example, implemented via Low Energy Bluetooth.

As may be understood from FIG. 1, the One or More Motion Sensors 158 may include, for example, a Magnetometer 162 (e.g., one or more magnetometers), a Gyroscope 164 (e.g., one or more gyroscopes), and/or an Accelerometer 166 (e.g., one or more accelerometers). In particular embodiments, the Magnetometer 162 may include any suitable magnetometer such as, for example, a suitable Microelectromechanical systems (MEMs) magnetometer (e.g., such as a Lorentz-force-based MEMs magnetometer). In other embodiments, the Magnetometer 162 may include any suitable 2-axis magnetometer or 3-axis magnetometer. In other embodiments, the Magentometer 162 may include any suitable 2-axis, 3-axis, 6 axis, or 9-axis sensor comprising one or more magnetometers, one or more accelerometers, and/or one or more gyroscopes. In still other embodiments, the Magnetometer 162 may include any other suitable sensor or magnetometer having any suitable number of axes.

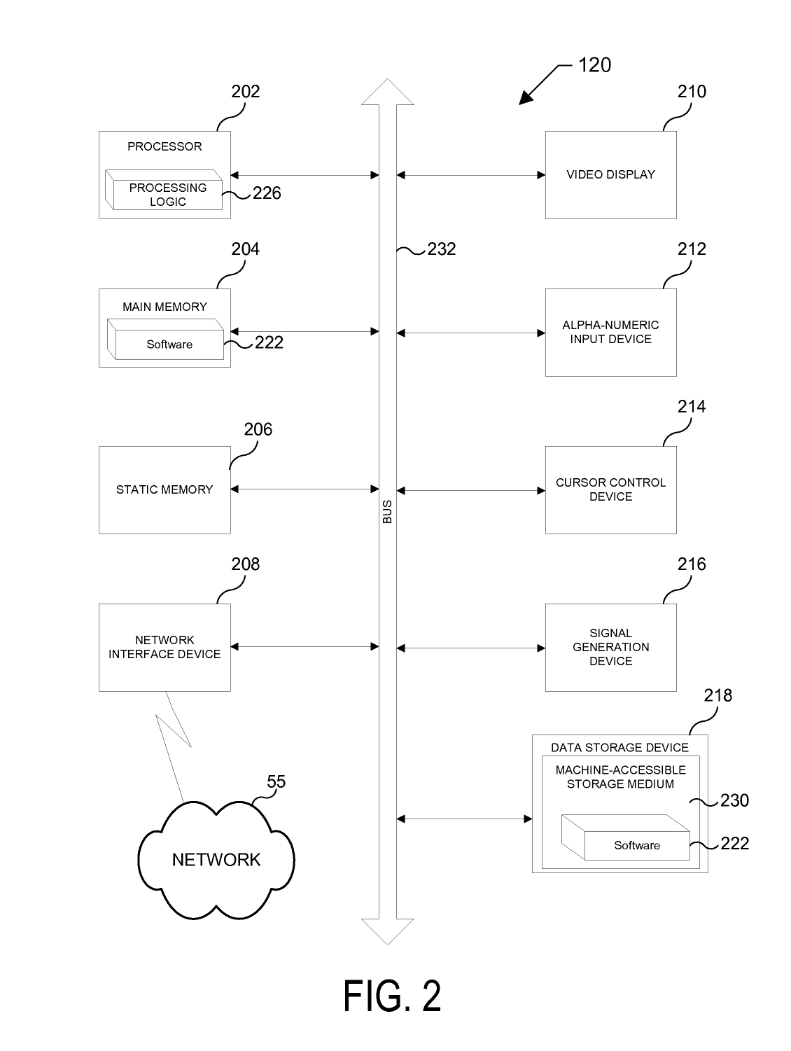

FIG. 2 illustrates a diagrammatic representation of a computer architecture 120 that can be used within the Vehicle Tracking System 10, for example, as a client computer (e.g., one of the One or More Mobile Computing Devices 154, 156 shown in FIG. 1), or as a server computer (e.g., Vehicle Tracking Server 100 shown in FIG. 1). In particular embodiments, the computer 120 may be suitable for use as a computer within the context of the Vehicle Tracking System 10 that is configured for determining, tracking, and storing Vehicle 170 movement information and providing access to the information to one or more user in the context of the system.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a wearable computing device (e.g., such as a wearable computing device embodied as a wristwatch, pair of eyewear, or other suitable wearable computing device), a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-accessible storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-accessible storage media. The software 222 may further be transmitted or received over a network 115 via a network interface device 208.

While the computer-accessible storage medium 230 is shown in an exemplary embodiment to be a single medium, the term “computer-accessible storage medium” should be understood to include a single medium or multiple media (e.g., a centralized or distributed database, and/or associated caches and servers) that store the one or more sets of instructions. The term “computer-accessible storage medium” should also be understood to include any medium that is capable of storing, encoding or carrying a set of instructions for execution by the computer and that cause the computer to perform any one or more of the methodologies of the present invention. The term “computer-accessible storage medium” should accordingly be understood to include, but not be limited to, solid-state memories, optical and magnetic media, etc.

### Exemplary Wearable Computing Device

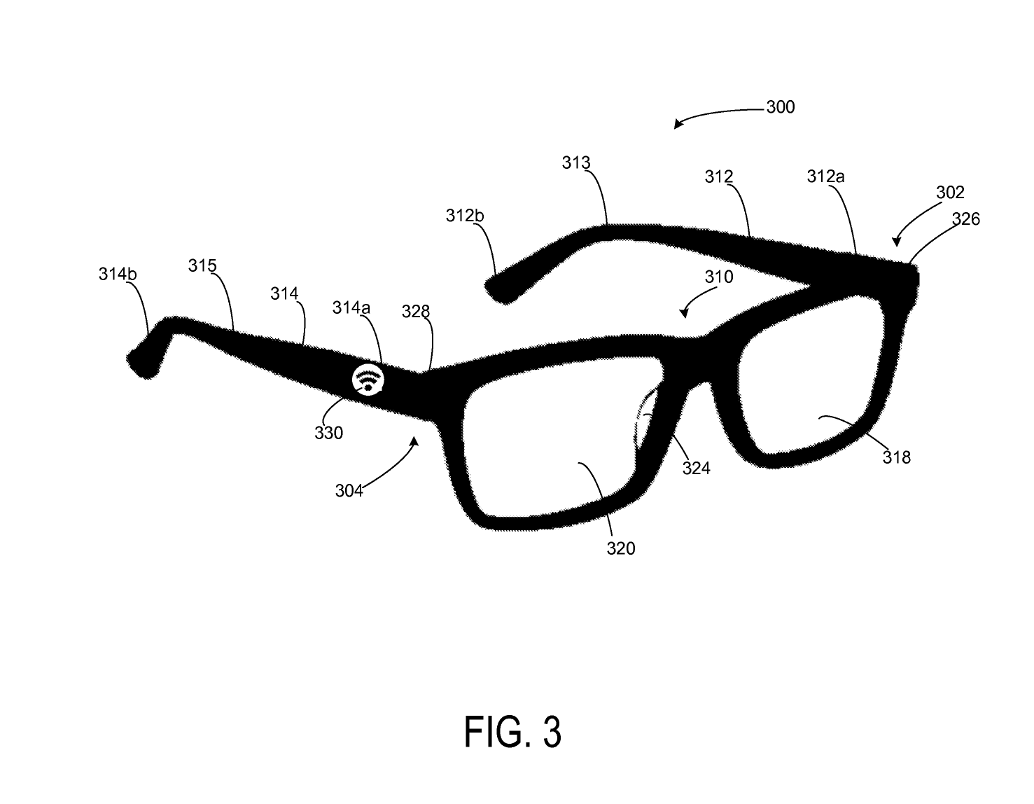

As shown in FIG. 1, the Vehicle Tracking System 10, in various embodiments, comprises One or More Wearable Computing Devices. A particular embodiment of a wearable computing device 300 is shown in FIG. 3. As shown in this figure, eyewear 300, according to various embodiments, includes: (1) an eyewear frame 310; (2) a first temple 312; and (3) a second temple 314. These various components are discussed in more detail below.

### Eyewear Frame

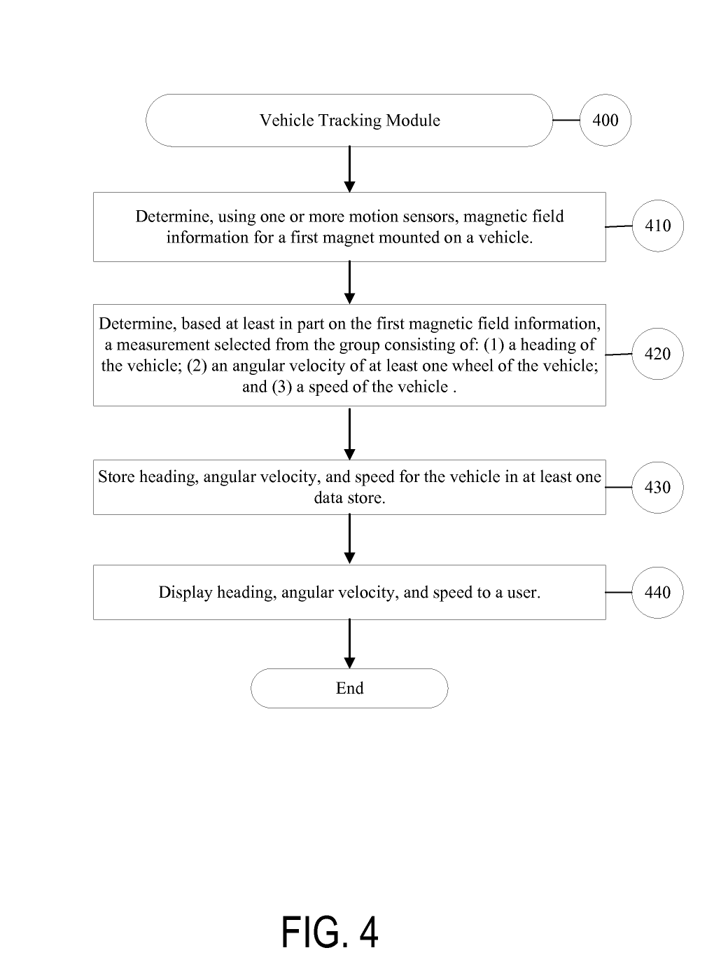

Referring still to FIG. 4, eyewear 300, in various embodiments, includes any suitable eyewear frame 310 configured to support one or more lenses 318, 320. In the embodiment shown in this figure, the eyewear frame 310 has a first end 302 and a second end 304. The eyewear frame 310 may be made of any suitable material such as metal, ceramic, polymers or any combination thereof. In particular embodiments, the eyewear frame 310 is configured to support the first and second lenses 318, 320 about the full perimeter of the first and second lenses 318, 320. In other embodiments, the eyewear frame 310 may be configured to support the first and second lenses 318, 320 about only a portion of each respective lens. In various embodiments, the eyewear frame 310 is configured to support a number of lenses other than two lenses (e.g., a single lens, a plurality of lenses, etc.). In particular embodiments, the lenses 318, 320 may include prescription lenses, sunglass lenses, or any other suitable type of lens (e.g., reading lenses, non-prescription lenses), which may be formed from glass or polymers.

The eyewear frame 310 includes a first and second nose pad 322 (not shown in figure), 324, which may be configured to maintain the eyewear 300 adjacent the front of a wearer's face such that the lenses 318, 320 are positioned substantially in front of the wearer's eyes while the wearer is wearing the eyewear 300. In particular embodiments, the nose pads 322, 324 may comprise a material that is configured to be comfortable when worn by the wearer (e.g., rubber, etc.). In other embodiments, the nose pads may include any other suitable material (e.g., plastic, metal, etc.). In still other embodiments, the nose pads may be integrally formed with the frame 210.

The eyewear frame 310 includes a first and second hinge 326, 328 that attach the first and second temples 312, 314 to the frame first and second ends 302, 304, respectively. In various embodiments, the hinges may be formed by any suitable connection (e.g., tongue and groove, ball and socket, spring hinge, etc.). In particular embodiments, the first hinge 326 may be welded to, or integrally formed with, the frame 310 and the first temple 312 and the second hinge 328 may be welded to, or integrally formed with, the frame 310 and the second temple 314.

### First and Second Temples

As shown in FIG. 4, the first temple 312, according to various embodiments, is rotatably connected to the frame 310 at a right angle to extend the first temple 312 substantially perpendicular, substantially parallel, or anywhere in between the right angle to the frame 310. The first temple 312 has a first and second end 312a, 312b. Proximate the first temple second end 312b, the first temple 312 includes an earpiece 313 configured to be supported by a wearer's ear. Similarly, the second temple 314, according to various embodiments, is rotatably connected to the frame 310 at a right angle to extend the second temple 314 substantially perpendicular, substantially parallel, or anywhere in between the right angle to the frame 310. The second temple 314 has a first and second end 314a, 314b. Proximate the second temple second end 314b, the second temple 314 includes an earpiece 315 configured to be supported by a wearer's ear.

### Sensors

In various embodiments, the second temple 314 has one or more sensors 330 connected to the second temple 314. In various embodiments, the one or more sensors 330 may be coupled to the frame 310, the first and second temples 312, 314, the first and second lenses 318, 310, or any other portion of the eyewear 300 in any suitable way. For instance, the one or more sensors 330 may be embedded into the eyewear 300, coupled to the eyewear 300, and/or operatively coupled to the eyewear 300. In various embodiments, the one or more sensors may be formed at any point along the eyewear 300. For instance, a fingerprint reader may be disposed adjacent the first temple of the eyewear 300. In various embodiments, the one or more sensors may be formed in any shape. In addition, the one or more sensors may be formed on the inner (back) surface of the frame 310, the first and second temples 312, 314, the first and second lenses 318, 310, or any other portion of the eyewear 300. In other embodiments, the one or more sensors may be formed on the outer (front) surface of the frame 310, the first and second temples 312, 314, the first and second lenses 318, 310, or any other portion of the eyewear 300.

In various embodiments, the one or more sensors 330 that are coupled to the eyewear (or other wearable device) are adapted to detect one or more characteristics of the eyewear or a wearer of the eyewear, wherein the one or more characteristics of the wearer are associated with the wearer's identity. In various embodiments, the one or more sensors coupled to the eyewear or other health monitoring device may include, for example, one or more of the following: a near-field communication sensor, a Bluetooth chip, a GPS unit, an RFID tag (passive or active), a fingerprint reader, an iris reader, a retinal scanner, a voice recognition sensor, a heart rate monitor, an electrocardiogram (EKG), a pedometer, a thermometer, a front-facing camera, an eye-facing camera, a microphone, an accelerometer, a magnetometer, a blood pressure sensor, a pulse oximeter, a skin conductance response sensor, any suitable biometric reader, or any other suitable sensor. In a particular embodiment, the one or more sensors 330 include the One or More Motion Sensors 158 shown in FIG. 1. In some embodiments, the one or more sensors may include a unique shape, a unique code, or a unique design physically inscribed into the eyewear that may be readable by an individual or a remote computing device. In particular embodiments, the sensors coupled to the eyewear may include one or more electronic communications devices such as a near field communication sensor, a Bluetooth chip, an active RFID, and a GPS unit.

In various embodiments, the one or more sensors are coupled to a computing device that is associated with (e.g., embedded within, attached to) the eyewear or other wearable device. In particular embodiments, the eyewear or other wearable device comprises at least one processor, computer memory, suitable wireless communications components (e.g., a Bluetooth chip) and a power supply for powering the wearable device and/or the various sensors.

In particular embodiments, the system is configured to receive input from a user (e.g., a wearer of the eyewear) via one or more gestures, for example, using at least one of the sensors described immediately above. In various embodiments, the system may, for example, be configured to: (1) identify a gesture performed by the user; and (2) at least partially in response to identifying the gesture, perform a function associated with the gesture. In particular embodiments, the system may be configured to perform a particular function in response to identifying a particular gesture, where the particular gesture is associated with the particular function. In particular embodiments, the system may be configured to enable the user to provide one or more gestures for performing a particular function. In such embodiments, the system may, for example: (1) receive a selection of a particular function from the user; (2) receive input of one or more gestures from the user; and (3) associated the particular function with the one or more gestures.

In various embodiments, the one or more gestures may include, for example: (1) one or more hand gestures (e.g., a thumbs up, a wave, two thumbs up, holding up any particular number of fingers, making one or more fists, performing a particular movement with one or more hands, etc.); (2) one or more head movements (e.g., shaking of the user's head, a nod, etc.); (3) one or more eye movements (e.g., looking in a particular direction for a particular period of time, a wink, blinking, blinking in a particular pattern, etc.); (4) one or more facial movements (e.g., a smile, a frown, sticking out of a tongue, etc.); and/or (5) any suitable combination of these or any other suitable gestures.

In particular embodiments, the system is configured to identify the one or more gestures, for example, using a suitable imaging device (e.g., camera) that is part of the system. In particular embodiments, the imaging device may be directed toward an area in front of the user while the user is wearing the eyewear 300 and configured to identify gestures performed by the user's hands, arms, feet, legs, etc. In other embodiments, the system may include an imaging device directed toward the user's face and/or eyes while the user is wearing the eyewear 300 that is configured to identify gestures performed by the user's face and/or eyes. In other embodiments, the system comprises one or more gyroscopes and/or accelerometers configured to determine a position or change in position of the eyewear 300 while the user is wearing the eyewear. In such embodiments, the one or more gyroscopes and/or accelerometers are configured to identify one or more gestures performed by the user that include none or more gestures that include movement of the user's head. In still other embodiments, the system comprises one or more gyroscopes and/or one or more accelerometers disposed on any other portion of the user's body configured to identify any gesture performed by the user using the other portion of the user's body (e.g., arm, hand, leg, foot, etc.). In various embodiments, the system comprises any other suitable sensor for identifying one or more gestures performed by the user.

### Exemplary System Platform

Various embodiments of a vehicle tracking system may be implemented within the context of any suitable vehicle. Although in the embodiment of the vehicle tracking system described below, the vehicle tracking system is described in the context of a bicycle, it should be understood that the vehicle tracking system may be implemented and utilized on any suitable motorized or non-motorized (e.g., human-powered) vehicle such as, for example: (1) any suitable single wheeled vehicle (e.g., such as a wheelbarrow, unicycle, etc.); (2) any suitable two-wheeled vehicle (e.g., such as a bicycle, motorcycle, cart, etc.); (3) any suitable three-wheeled vehicle (e.g., such as a tricycle, three-wheeled automobile, etc.); (4) any suitable four-wheeled vehicle (e.g., such as an automobile, truck, skateboard, etc.); and/or (5) any other suitable vehicle having any other suitable number of wheels (e.g., such as a street luge board, a pair of rollerblades or roller-skates, etc.). In still other embodiments, the vehicle tracking system may be implemented in the context of any suitable stationary bicycle (e.g., an exercise bike), any suitable indoor cycling bike, or any other suitable type of bike. Various aspects of the system's functionality may be executed by certain system modules, including a Vehicle Tracking Module 400, which may, for example, be executed by a software application running on a suitable mobile computing device (e.g., a cellular phone or tablet computer), a suitable wearable computing device (e.g., a wristwatch, pair of eyewear, etc.) or other computing device. This module is discussed in greater detail below.

Vehicle Tracking Module

As shown in FIG. 3, when executing the vehicle tracking module 400, the system begins, at Step 410, by determining, using one or more motion sensors, magnetic field information for a first magnet mounted on a vehicle (e.g., a bicycle). In particular embodiments, the one or more motion sensors may include, for example: (1) one or more magnetometers; (2) one or more accelerometers; and/or (3) one or more gyroscopes. In some embodiments, the one or more motion sensors comprise at least one magnetometer. In a particular embodiment, the at least one magnetometer comprises at least one MEMs Blue Tooth Low Energy magnetometer. In various embodiments, the one or more motion sensors are embedded in (e.g., integrated with) a mobile computing device. In particular embodiments the mobile computing device may comprise any suitable mobile computing device such as, for example, a smartphone, tablet computer, self-contained tracking device, wearable computing device (e.g., a pair of eyewear, a bracelet, a watch, a helmet), etc.

In various embodiments, the magnetic field information determined by the one or more motion sensors includes a strength and direction of the magnetic field of the first magnet. In other embodiments, the magnetic field information includes an absolute heading of the first magnet's magnetic field with respect to earth magnetic north, or any other suitable reference direction. In still other embodiments, the system is configured to determine the magnetic field information based at least in part on a magnetic field produced by the first magnet. In particular embodiments, the system is configured to substantially continuously determine the magnetic field information for the first magnet. The system may, for example, substantially continuously record the magnetic field information and store the magnetic field information in a suitable database (e.g., in a local data store associated with the first magnetometer, in a local data store associated with a suitable mobile computing device, and/or any other suitable data store such as a remote data store).

In particular embodiments, the first magnet is disposed on a particular portion of the bicycle. For example, in a particular embodiment, the first magnet is disposed on a particular portion of one of the bicycle's wheels (e.g., on the wheel's tire, rim, valve, spoke, hub, or any suitable portion thereof), on a particular portion of the bicycle's frame, or in any other suitable location. In a particular embodiment, the first magnet is disposed on one of the bicycle's wheels such that the first magnet's magnetic field is substantially aligned with (e.g., aligned with) a radius of the bicycle's wheel (e.g., the first magnet may be disposed on one of the wheel's spokes with the first magnet's magnetic field substantially parallel to the spoke). In still other embodiments, the first magnet may be disposed such that the first magnet's magnetic field is substantially perpendicular (e.g., perpendicular) to the bicycle wheel's radius (e.g., substantially tangent to the bicycle's wheel). In still other embodiments, the first magnet may be disposed on the bicycle wheel such that the first magnet's magnet field is oriented in any other suitable manner relative to the bicycle wheel. In various embodiments, the first magnet may be disposed on any suitable portion of the bicycle's front or rear wheel. In still other embodiments, the first magnet may be disposed on any suitable portion of the bicycle frame. In another embodiment, the first magnet may be disposed on any suitable portion of the bicycle's pedals, on any suitable portion of the bicycle's chain, on any suitable portion of the bicycle's handlebars, or in any other suitable location on the bicycle.

Returning to FIG. 3, the system continues at Step 420 by determining, based at least in part on the first magnetic field information, a measurement selected from the group consisting of: (1) a heading of the vehicle; (2) an angular velocity of at least one wheel of the vehicle; and (3) a speed of the vehicle. In particular embodiments, the system is configured to determine a substantially instantaneous heading of the bicycle (e.g., a direction in which the bicycle is currently travelling). In such embodiments, the heading of the bicycle may include a direction relative to a fixed direction (e.g., relative to magnetic north), for example, in degrees (e.g., between about 0 degrees and about 360 degrees where 0 degrees is magnetic north). In particular embodiments, the heading may also include an angle of incline or decline of the bicycle, for example, when the bicycle is travelling up or downhill. In a particular example, the system may be configured to determine that the bicycle is travelling downhill at a slope of a particular number of degrees or uphill at a slope of a particular number of degrees. In various embodiment, the system is configured to substantially continuously determine the heading of the bicycle. In some embodiments, the system is configured to track the heading of the bicycle over time. In such embodiments, the system may be configured to determine a path or course travelled by the bicycle from a particular starting point based at least in part on determined heading information.

In a particular embodiment, the system, when determining the magnetic field information, is configured to: (1) receive a first magnetic field measurement for the first magnet at a first time from the one or more motion sensors (e.g., the one or more magnetometers); and (2) receive a second magnetic field measurement for the first magnet at a second time from the one or more motion sensors (e.g., the one or more magnetometers). In various embodiments, the first and second magnetic field measurements comprise a strength and a direction of the first magnet's magnetic field at the time at which the magnetic field measurement was taken (e.g., at the first or second time). In various embodiments, the system is configured to: (1) determine a first angle of revolution of the bicycle wheel at the first time based at least in part on the first magnetic field measurement; and (2) determine a second angle of revolution of the bicycle wheel at the second time based at least in part on the second magnetic field measurement. The system is then, in particular embodiments, configured to determine the angular velocity of the wheel based at least in part on a difference in the first and second angles of revolution and the time elapsed between the first and second time. In various embodiments, the system is configured to determine an angle of revolution of the bicycle wheel at a particular time based at least in part on the magnetic field information, an orientation of the first magnet on the bicycle (e.g., on the bicycle wheel), or using any other suitable technique.

In various embodiments, the system is configured to determine the angular velocity of the bicycle wheel by: (1) determining, based at least in part on the magnetic field information, an elapsed time during at least a fractional revolution of the bicycle wheel; and (2) determining, based at least in part on the elapsed time and the at least a fractional revolution, an angular velocity of the bicycle wheel. The system may, for example, determine the elapsed time for a substantially full revolution (e.g., one revolution) of the bicycle wheel in order to determine the angular velocity. In still other embodiments, the system is configured to determine angular velocity using any other suitable fractional wheel revolution. In various embodiments, the system is configured to substantially continuously (e.g., continuously) determine the angular velocity of the bicycle wheel. In various embodiments, the system is further configured to determine a change in angular velocity of the bicycle wheel (e.g., an angular acceleration of the bicycle wheel).

In particular embodiments, the system is configured to utilize any suitable regression technique to determine an instantaneous angular velocity and/or instantaneous angular acceleration of the bicycle wheel. The system may, for example, use any suitable regression technique using any suitable number of data points (e.g., any suitable number of magnetic field measurements taken over any suitable period of time). In various embodiments, an increase in a frequency of taking magnetic field measurements may improve an accuracy of a determined instantaneous angular velocity or other measurement. In particular embodiments, the system is configured to take a plurality of magnetic field measurements over a particular period of time.

In particular embodiments, the system is configured to determine a speed of the bicycle (e.g., a speed of the bicycle relative to the Earth's surface). In such embodiments, the system may be configured to determine the speed of the bicycle based at least in part on the angular velocity of the bicycle wheel and a radius of the wheel. In other embodiments, the system is configured to determine the speed of the bicycle based on any other suitable measure or technique.

In various embodiments, the system is further configured to determine, based at least in part on determined velocities and headings over a particular period of time, a total distance travelled by the bicycle. In still other embodiments, the system is configured to determine an angle of approach for particular turns taken by the bicycle based at least in part on the determined headings (e.g., instantaneous directions of travel) of the bicycle. In still other embodiments, the system is configured to determine a total distance climbed and/or descended by the bicycle during a particular period of time.

In particular embodiments, the system is configured to generate, based at least in part on the heading and speed data, a visual representation of a path travelled by the bicycle over a particular period of time. The system may, for example, generate a two-dimensional or three-dimensional image that includes a line or other indication of a path travelled by the bicycle. The generated visual representation may, for example, be superimposed over a map or other representation of an area in which the bicycle is or was travelling.

Returning to Step 430, the system stores heading, angular velocity, speed data, and other movement data for the vehicle in at least one data store. In particular embodiments the at least one data store is a local data store associated with a mobile computing device from which the one or more motion sensors took measurements related to the first magnet's magnetic field. In other embodiments, the at least on data store comprises one or more remote servers (e.g., cloud-based storage servers). In still other embodiments, the data store may include any suitable data store. In particular embodiments, the system is configured to enable a user to retrieve the stored data using a suitable computing device.

Continuing to Step 440, the system displays the heading, angular velocity, speed, visual representation of the path of the vehicle over a particular period of time, or any other information related to the movement of the bicycle determined by the system to a user. In various embodiments, the system is configured to display the heading, angular velocity, and speed on a display associated with a mobile computing device comprising the first magnetometer that measured the first magnetic field information. In other embodiments, the system is configured to display the information on any other suitable display. In particular embodiment, the sure may include any suitable user such as, for example, the rider of the bicycle, the rider or driver (e.g., in the case of a vehicle other than a bicycle), or any other suitable person.

### Illustrative Example and User Experience

In a particular example of a vehicle tracking system, a bicycle rider may utilize the vehicle tracking system to track the rider's speed, distance covered, distance climbed, or any other suitable measurement as the rider is riding the bicycle. For the purposes of this illustrative example, the bicycle rider is utilizing the vehicle tracking system embodied as a wearable computing device in the form of a pair of eyewear with an embedded magnetometer. In this example, the rider would affix (e.g., permanently affix, at least temporality affix, etc.) a magnet to a suitable portion of the rear wheel of their bicycle. The user may, for example, affix the magnet to a spoke of the back wheel of their bicycle using a hook and loop fastener, or in any other suitable manner.

The user would then climb onto their bicycle, put on the pair of eyewear, and initiate a vehicle tracking program. The user may, for example, initiate the vehicle tracking program by issuing one or more voice commands to the pair of eyewear. In response to the request from the user to begin tracking, the system would then begin tracking the movement of the bicycle by, for example: (1) receiving, from the magnetometer, one or more magnetic field measurements for the magnet; and (2) determine, based at least in part on the one or more magnetic field measurements, an angular velocity of the bicycle' rear tire; and (3) use the determined angular velocity to determine, for example a speed of the bicycle, a distance travelled by the bicycle during the ride, a highest climbed by the bicycle, etc.

During the ride, the rider may, for example, prompt the pair of eyewear to announce a current speed of the bicycle, a total distance travelled, or any other piece of information. The rider may, for example, request particular pieces of data using one or more voice commands (e.g., “How fast am I going”, etc.). The pair of eyewear may report the requested data, for example, via one or more speakers embedded in the pair of eyewear.

In various embodiments, the pair of eyewear may be configured to receive requests and display information via a suitable display screen, which may, in some embodiments, be embedded in the pair of eyewear. In other embodiments, the pair of eyewear may be configured to receive requests and display information on a mobile computing device (e.g., such as a smartphone) with which the pair of eyewear is configured to communicate using any suitable wireless protocol (e.g., Bluetooth, near-field communication, etc.).

### Alternative Embodiments

Particular embodiments of a vehicle tracking may include features in addition to those discussed above. Various alternative embodiments are discussed more fully below.

Magnetic Field Information Determination for a Plurality of Magnets

In various embodiments, the system is further configured to determine magnetic field information for a second magnet mounted on the vehicle, for example, using the first magnetometer or using a second magnetometer. In such embodiments, the first magnet may, for example, be disposed on a first portion of the vehicle (e.g., on the rear wheel of a bicycle), and the second magnet may be disposed, for example, on a second portion of the vehicle (e.g., on the rear wheel of the bicycle). In such embodiments, the system may be configured to determine angular velocity, speed, and heading information for both the front and rear tire. In various embodiments, the system may determine more accurate heading information for a bicycle or other vehicle using a plurality of magnets, for example, because the front and rear tires are not aligned while the bicycle is turning.

In such embodiments, the system may be configured to determine speed, distance and other information about the vehicle based in part on measurements made for and determined from magnetic field information for both the first and second magnet. As may be understood by one skilled in the art, both tires of a bicycle may not rotate in identical manners or accurately reflect a distance traveled by or speed of the bicycle itself. For example, one or more bicycle wheels may slip (e.g., due to surface conditions), one or more bicycle wheels may leave the support surface during a ride (e.g., after travelling over a bump) causing the bicycle wheel to rotate without resulting in a corresponding change in position of the bicycle.

In various embodiments, the system is configured to normalize speed and other movement data for the bicycle based on measurements determined from both the first and second magnets. In such embodiments, the system is configured to correct for errors in determined speed, distance travelled, etc. which may result from relying on measurements taken from a single magnet on a single bicycle tire.

In various embodiments, the system may comprise a first magnet disposed on a bicycle wheel and a second magnet disposed on a bicycle pedal. In such embodiments, the system is configured to determine a correlation between pedal speed and bicycle speed. In such embodiments, the system may be configured to: (1) determine angular velocity of the bicycle pedal; (2) determine angular velocity of the bicycle wheel; and (3) determine a correlation between the angular velocity of the bicycle pedal and the bicycle wheel based at least in part on a gear in which the rider has placed the bicycle, or any other suitable factor. In various embodiments, the system may be further configured to determine a rate at which the bicycle loses speed while the rider is not pedaling (e.g., coasting) at various levels of incline or decline.

Use of One or More Additional Sensors to Determine Additional Information for a User

In various embodiments, the system is configured to utilize information received from or determined by one or more sensors in addition to the magnetometer discussed above. These additional sensors are discussed below.

Global Positioning System

In various embodiments, the system is configured to use a suitable global positioning system to determine a substantially current location of a vehicle. In such embodiments, the system may be configured to use any suitable dead reckoning technique to determine a change in location or substantially current (e.g., current) location of a vehicle based on a starting location (e.g., a starting location determined using GPS) and heading and velocity information determined using a magnetometer as discussed above. The system may for example, determine a current location of the vehicle by determining the current location based on directions in which the vehicle travelled from the starting location and how long and at what speed the vehicle travelled in any particular direction from the starting location.

One or More Pressure Sensors

In various embodiments, the system is configured to use one or more pressure sensors to determine other suitable information about a rider's use of the bicycle. For example, the system may comprise one or more pressure sensors disposed on the bicycle seat, handlebars, pedals, or in any other suitable location. The system may then be configured to collect data, using the one or more pressure sensors, such as, for example: (1) in/out saddle times; (2) force exerted on the pedals by the rider; (3) force exerted on the handlebars by the rider; and/or (4) any other suitable information. The system may then, for example, use force information to determine, for example, an amount of acceleration that the rider can achieve with the bicycle under certain conditions while pedaling at a particular intensity, speed and acceleration differences that the vehicle experiences while the rider is pedaling while in the saddle versus in a standing position, or make any other suitable determination.

One or More Rider Health Monitors

In various embodiments, the system is configured to use one or more rider health monitors to monitor a rider's health, and provide feedback (e.g., instantaneous feedback or post-ride feedback) to the rider. In various embodiments, the one or more rider health monitors may include, for example, one or more heart rate monitors, one or more perspiration rate monitors, one or more pulse oximeters, one or more respiration rate monitors, one or more energy output monitors (e.g., for monitoring calorie burn over time), or any other suitable health monitor. The system may, for example, use one or more heart monitors to determine a variability of a rider's heart rate, for example, by measuring a time between heart beats of the rider, a change in time between heartbeats, etc.

As a particular example, the system may be configured to utilize one or more heart rate monitors to monitor a rider's heart rate during a particular ride. In particular embodiments, the system is configured to track a rider's heart rate during a particular ride and provide heart rate data to the rider to enable the rider to review the rider's heart rate during particular portions of the ride. The system may, for example: (1) enable the rider to provide a target heart rate; (2) receive a desired target heart rate from the rider; (3) monitor the rider's heart rate during a particular ride; (4) determine whether the rider's heart rate is at least about the desired target heart ride during the particular ride; and (5) in response to determining that the rider's heart rate is not at least about the desired target hear rate, notify the rider that the rider should increase the rider's exertion level in order to elevate the rider's heart rate. In still other embodiments, the system may be configured to monitor the rider's heart rate and provide a warning to the rider in response to determining that the rider's heart rate has exceeded a threshold level or has exceeded a particular level for a particular length of time. In various embodiments, the threshold level may be determined based in part on a rider's age, gender, overall health, one or more health conditions that the rider is experiencing, or any other suitable factor.

Rider Performance Recommendation

In various embodiments, the system is configured to enable a rider or another individual to review performance data during a particular ride. The system may, for example, enable a rider to review portions of a particular ride where the rider lost speed (e.g., due to changing direction too rapidly, failing to pedal quickly enough out of a turn, etc.). In various embodiments, the system may be configured to substantially automatically determine techniques for improving a rider's performance over a particular course. The system may, for example, determine, based on speed, acceleration, and heading data, a substantially optimal portion of a particular turn or type of turn at which the rider should accelerate (e.g., begin to pedal or pedal harder), an angle at which a rider should approach the particular turn (e.g., a turn of a particular degree), or make any other suitable determination in order to substantially maximize a speed of the bicycle as the rider exits the particular turn. In various embodiments, the system is configured to determine optimal approaches to various bike riding events based at least in part on the rider's own past performance data.

Non-Vehicular Motion Tracking Using One or More Magnetometers

In various embodiments, the system is configured to utilize one or more magnetometers and one or more magnets to track movement of one or more objects and/or individuals other than a vehicle. In particular embodiments, the system is configured to use the one or more magnetometers and the one or more magnets to track movement where the movement is substantially repetitive, or has a substantially consistent pattern. In some embodiments, the system may, for example, be configured to track movement such as, for example, rowing (e.g., using one or more magnets on an oar or paddle to track the number of strokes executed or other suitable data), weight lifting (e.g., using one or more magnets on or adjacent a particular portion of a weight lifter's body, or on a particular piece of weight lifting equipment to count a number of reps or other suitable data), swimming (e.g., using one or more magnets on a swimmer's arm, leg, etc. to count a swimmer's strokes or other data), or any other suitable activity.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. In particular, it should be understood that although various embodiments of a vehicle tracking system are described above in the context of a bicycle, the invention can be embodied and utilized in tracking any other suitable type of vehicle, such as any other type of vehicle mentioned above. Although specific terms are employed herein, they are used in a generic and descriptive sense only and not for the purposes of limitation.

What is claimed is:

1. A computer-implemented method of determining vehicle motion, the method comprising:
determining, by a processor, using one or more magnetometers, magnetic field information for a first magnet mounted on a wheel of a vehicle at a particular time;
determining, by a processor, based at least in part on the magnetic field information, an angular velocity of the vehicle wheel at the particular time;
determining, by a processor, based at least in part on the angular velocity, a speed of the vehicle at the particular time; and
reporting the speed of the vehicle to a user of the vehicle.

2. The computer-implemented method of claim 1, wherein:
determining the magnetic field information for the first magnet comprises:
receiving, at a first time, a first magnetic field measurement from the one or more magnetometers; and
receiving, at a second time, a second magnetic field measurement from the one or more magnetometers; and
determining the angular velocity of the wheel based at least in part on the magnetic field information comprises:
determining a time difference between the first time and the second time; and
determining the angular velocity based at least in part on the first magnetic field measurement, the second magnetic field measurement, and the time difference.

3. The computer-implemented method of claim 2, wherein determining the angular velocity based at least in part on the first magnetic field measurement, the second magnetic field measurement, and the time difference comprises:
determining a first wheel angle of rotation based at least in part on the first magnetic field measurement; and
determining a second wheel angle of rotation based at least in part on the second magnetic field measurement.

4. The computer-implemented method of claim 3, wherein determining the angular velocity based at least in part on the first magnetic field measurement, the second magnetic field measurement, and the time difference comprises determining an angular difference between the first angle of rotation and the second angle of rotation.

5. The computer-implemented method of claim 4, wherein the first magnetic field measurement is a measurement selected from the group consisting of:
i. a strength of the first magnetic field; and
ii. a direction of the first magnetic field.

6. The computer-implemented method of claim 1, wherein the one or more magnetometers are at least partially embedded in a pair of eyewear.

7. The computer-implemented method of claim 6, wherein the vehicle is a bicycle.

8. The computer-implemented method of claim 1, the method further comprising:
determining, by a processor, using one or more magnetometers, a plurality of substantially instantaneous magnetic field information for the first magnet over a particular period of time;
determining, by a processor, based at least in part on the plurality of substantially instantaneous magnetic field information, a plurality of substantially instantaneous angular velocities of the vehicle wheel and a plurality of substantially instantaneous directions of travel of the vehicle over the particular period of time; and
determining, by a processor, based at least in part on the plurality of substantially instantaneous angular velocities, a plurality of substantially instantaneous speeds of the vehicle over the particular period of time.

9. The computer implemented method of claim 8, the method further comprising:
generating, by a processor, based at least in part on the plurality of substantially instantaneous directions of travel and the plurality of substantially instantaneous speeds of the vehicle, a visual representation of a path travelled by the vehicle during the particular period of time; and
displaying, by a processor, the visual representation of the path to the user.

10. A computer system for determining and tracking bicycle movement data comprising:
at least one processor; and
at least one magnetometer, wherein the computer system is configured for:
receiving, from the at least one magnetometer at a first time, a first magnetic field measurement for a first magnet disposed on a portion of a bicycle selected from the group consisting of:
a wheel of the bicycle; and
a portion of a pedal of the bicycle;
receiving, from the at least one magnetometer at a second time, a second magnetic field measurement for the first magnet;
determining, based at least in part on the first magnetic field measurement and the second magnetic field measurement, a velocity of the bicycle; and
storing the velocity of the bicycle in at least one data store.

11. The computer system of claim 10, wherein the computer system is further configured for:
determining a velocity of the bicycle over a particular period of time; and
determining, based at least in part on the velocity of the bicycle over the particular period of time, a distance travelled by the bicycle over the particular period of time.

12. The computer system of claim 10, wherein the computer system is further configured for:
determining based at least in part on the first magnetic field measurement, a first heading of the bicycle at the first time;
determining based at least in part on the second magnetic field measurement, a second heading of the bicycle at the second time;
storing the first heading and the second heading in at least one data store.

13. The computer-system of claim 12, wherein the computer system is further configured for:
determining a starting location of the bicycle at the first time; and
determining an ending location of the bicycle at the second time based at least in part on, the starting location, the first heading, the second heading, and the velocity of the bicycle.

14. The computer system of claim 10, wherein the computer system is further configured for:
receiving, from the at least one magnetometer at a third time, a third magnetic field measurement for the first magnet; and
determining, based at least in part on the first magnetic field measurement, the second magnetic field measurement, and the third magnetic field measurement, a change in velocity of the bicycle.

15. The computer system of claim 14, wherein:
the first magnet is disposed on the wheel of the vehicle;
a second magnet is disposed on the portion of the pedal of the vehicle; and
the computer system is further configured for:
receiving, from the at least one magnetometer at the first time, a fourth magnetic field measurement for the second magnet:
receiving, from the at least one magnetometer at the second time, a fifth magnetic field measurement for the second magnet;
determining, based at least in part on the fourth magnetic field measurement and the fifth magnetic field measurement, an angular velocity of the pedal;
determining, based at least in part on the change in velocity of the bicycle and the angular velocity of the pedal, a correlation between the change in velocity of the bicycle and the angular velocity of the pedal; and
providing the determined correlation to a rider of the bicycle.

16. A computer-implemented method of determining instantaneous angular velocity of a wheel of a vehicle, the method comprising:
receiving, by a processor, from one or more magnetometers, a plurality of magnetic field measurements for a first magnet mounted on the wheel over a particular period of time; and
determining, by a processor, based at least in part on the plurality of magnetic field measurements, an instantaneous angular velocity of the wheel at a particular time during the particular period of time.

17. The computer-implemented method of claim 16, wherein:
determining the instantaneous angular velocity of the wheel at the particular time comprises determining, by a processor, based at least in part on the plurality of magnetic field measurements, an angle of revolution of the wheel associated with each particular one of the plurality of magnetic field measurements.

18. The computer-implemented method of claim 17, the method further comprising:
determining, based at least in part on the instantaneous angular velocity of the wheel, an instantaneous velocity of the vehicle.

19. The computer-implemented method of claim 18, the method further comprising:
determining, by a processor, based at least in part on the plurality of magnetic field measurements, a plurality of instantaneous angular velocities of the wheel over the particular period of time; and
determining, by a processor, based at least in part on the plurality of instantaneous angular velocities of the wheel, a distance travelled by the vehicle during the particular period of time.

20. The computer-implemented method of claim 19, the method further comprising:
displaying, by a processor, the instantaneous velocity and the distance travelled to a rider of the vehicle.
